(19) United States
(12) Patent Application Publication
(10) Pub. No.: US 2019/0210241 A1
(43) Pub. Date: Jul. 11, 2019

(54) LINEAR GUIDE MECHANISM OF POWER MITER SAW

(71) Applicant: Chin-Chin Chang, Taichung City (TW)

(72) Inventor: Chin-Chin Chang, Taichung City (TW)

(21) Appl. No.: 15/867,648

(22) Filed: Jan. 10, 2018

(51) Int. Cl. B27B 5/20; B23D 47/02; B23D 45/04

(52) U.S. Cl. CPC B27B 5/208; B23D 45/048; B23D 47/02

(57) ABSTRACT

A power miter saw includes a rotatable table on a base; a saw blade and motor mechanism; and two linear guide mechanisms each interconnecting the table and the saw blade and motor mechanism. The linear guide mechanism is provided with a first link, a spring biased second link pivotably secured to the first link, a fastener for fastening the second link and the positioning seat together; a projection on the first link; and a latch pivotably secured onto the second link and including first and second slots. In a first locked position, the second slot is placed on the projection. In a second locked position, the first slot is placed on the projection.

### BACKGROUND OF THE INVENTION

### 1. Field of the Invention

The invention relates to power miter saw and more particularly to a linear guide mechanism of a power miter saw having improved characteristics.

### 2. Description of Related Art

U.S. Pat. No. 6,892,618 to the present inventor Chang discloses a circular sawing machine comprising a base; a saw seat movable relative to the base; and a link mechanism pivotally mounted between the base and the saw seat. The saw seat is linearly movable relative to the base. The link mechanism has a symmetrical structure so that the saw seat can be moved linearly relative to the base by linear movement of the link mechanism. The link mechanism includes a positioning seat secured on the base, two symmetrically opposite first links each having a first end mounted on the positioning seat, two symmetrically opposite second links each having a first end pivotally mounted on a second end of a respective one of the two first links, and two symmetrically opposite third links each having a first end pivotally mounted on a second end of a respective one of the two second links and a second end pivotally mounted on a connecting seat which is mounted on the saw seat.

While the device enjoys its success in the market, continuing improvements are constantly being sought.

### SUMMARY OF THE INVENTION

It is therefore one object of the invention to provide a power miter saw comprising a base; a table rotatably mounted on the base; a saw blade and motor mechanism configured to rotate a circular saw blade thereof; and two linear guide mechanisms each connected to a rear support seat of the base by means of a lower positioning seat, and connected to the saw blade and motor mechanism by means of an upper connecting seat, thereby supporting the saw blade and motor mechanism; wherein the linear guide mechanism comprises a first link including a bifurcated first end having two opposite first through holes, and a bifurcated second end having two opposite second through holes; and a fastener driven through the second through holes and two through holes of the connecting seat to fasten the first link and the connecting seat together; a second link including a bifurcated first end having two opposite first through hole, and a bifurcated second end having two opposite second through hole; a pivot driven through the first through holes and the first through hole to pivotably secure the first and second links together; and a fastener driven through the second through hole and two through holes of the positioning seat to fasten the second link and the positioning seat together; a projection disposed on an outer surface of the first link; and a latch pivotably secured to an outer surface of the second link and including a first slot at a first end, and a second slot adjacent to the first slot; wherein in a first locked position, the second slot is placed on the projection; wherein in a second locked position, the first slot is placed on the projection; and wherein in an operating position, the first and second links are unlocked by the latch.

The above and other objects, features and advantages of the invention will become apparent from the following detailed description taken with the accompanying drawings.

### BRIEF DESCRIPTION OF THE DRAWINGS

FIG. 1 is a perspective view of a power miter saw according to the invention;

FIG. 2 is a perspective view of the linear guide mechanism and associated components;

FIG. 3 is another view of FIG. 2;

FIG. 3A is a view similar to FIG. 3 showing the locked linear guide mechanism;

FIG. 4 is an exploded view of one linear guide mechanism and associated components;

FIG. 5 is a front view of FIG. 3;

FIG. 5A is a front view of FIG. 3 in part section;

FIG. 6 is a top view of the unlocked linear guide mechanism;

FIG. 7 is a view similar to FIG. 6 showing the pivoting linear guide mechanism;

FIG. 8 is a side elevation of the power miter saw with the linear guide mechanism being locked in a first position;

FIG. 9 is a view similar to FIG. 8 showing the movement of the saw blade and motor mechanism after unlocking the linear guide mechanism;

FIG. 10 is a top view of the linear guide mechanism being locked in a first position;

FIG. 10A is a view similar to FIG. 10 showing the linear guide mechanism being locked in a second position; and

FIG. 11 is a view similar to FIG. 8 with the linear guide mechanism being locked in a second position.

### DETAILED DESCRIPTION OF THE INVENTION

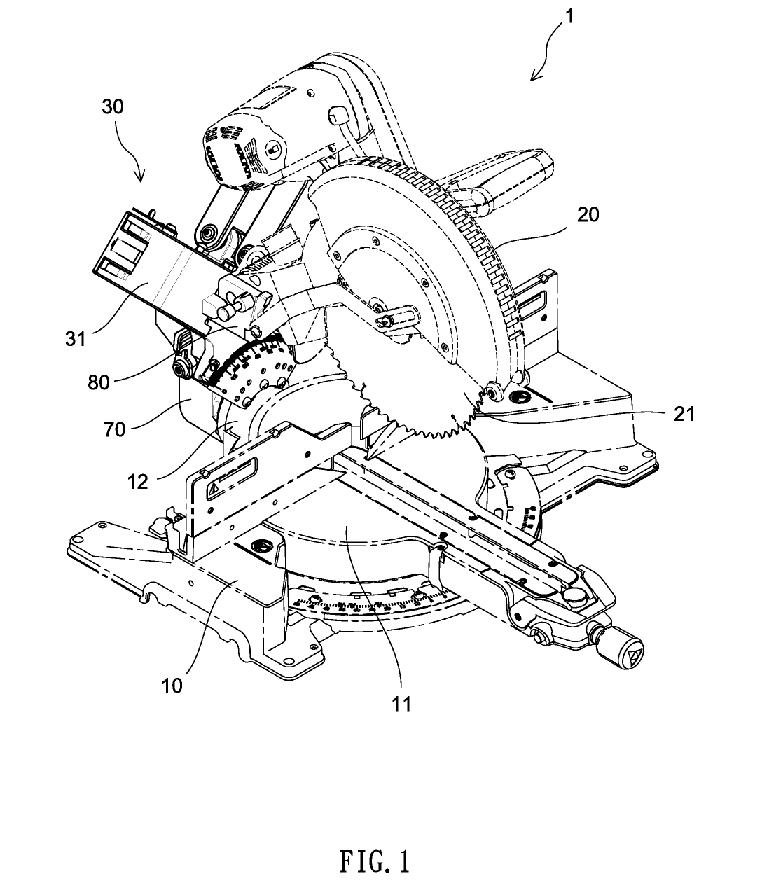

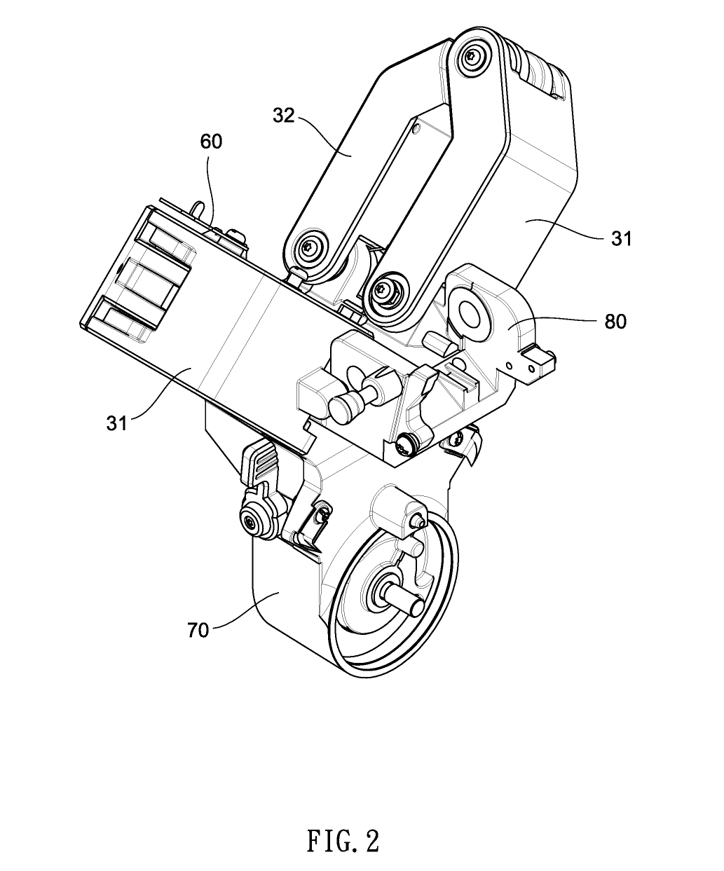

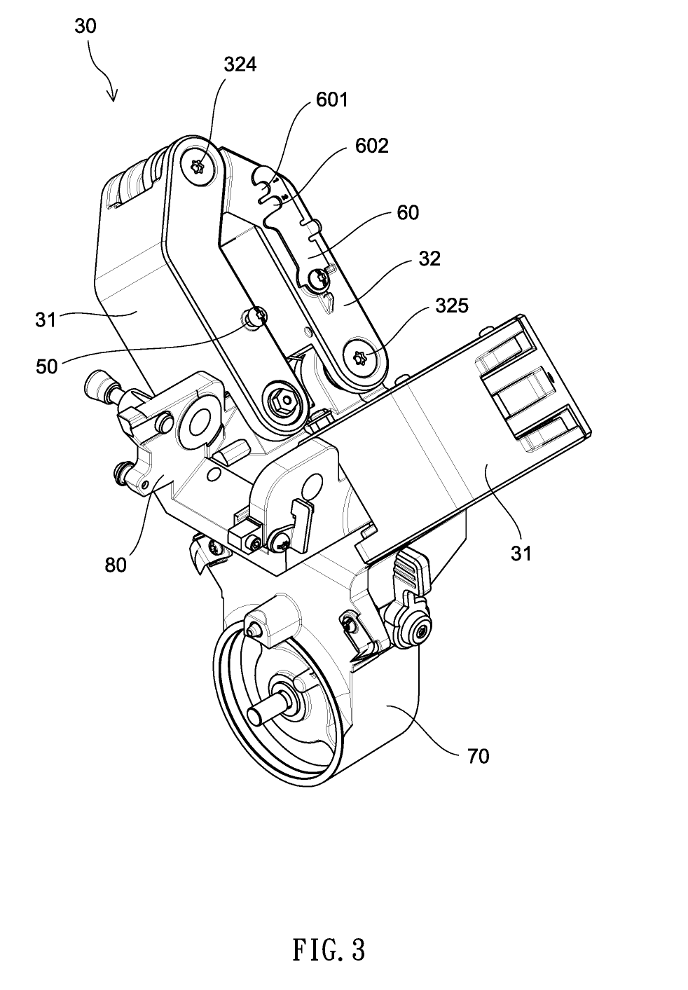

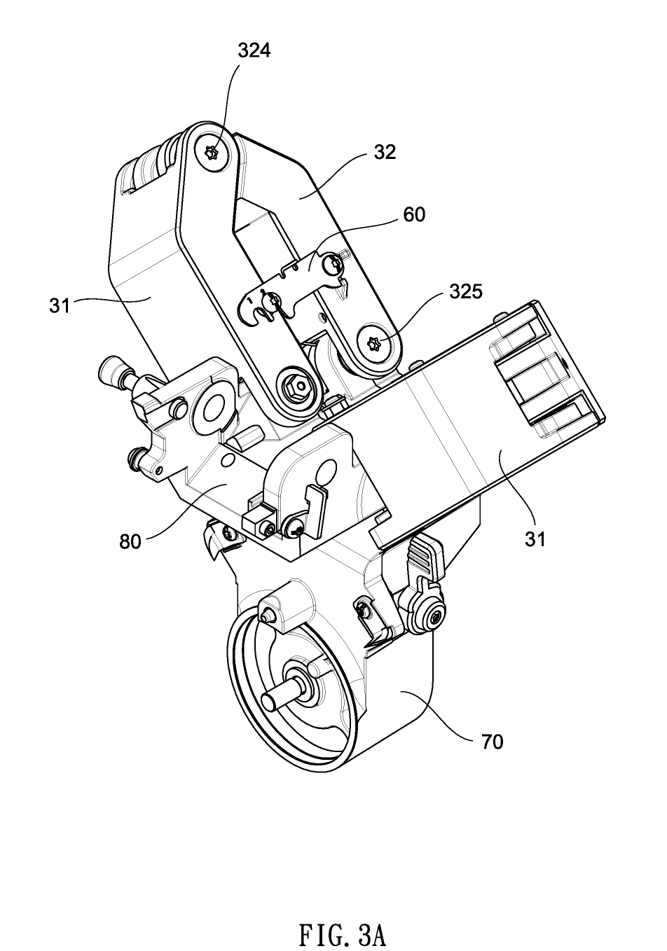

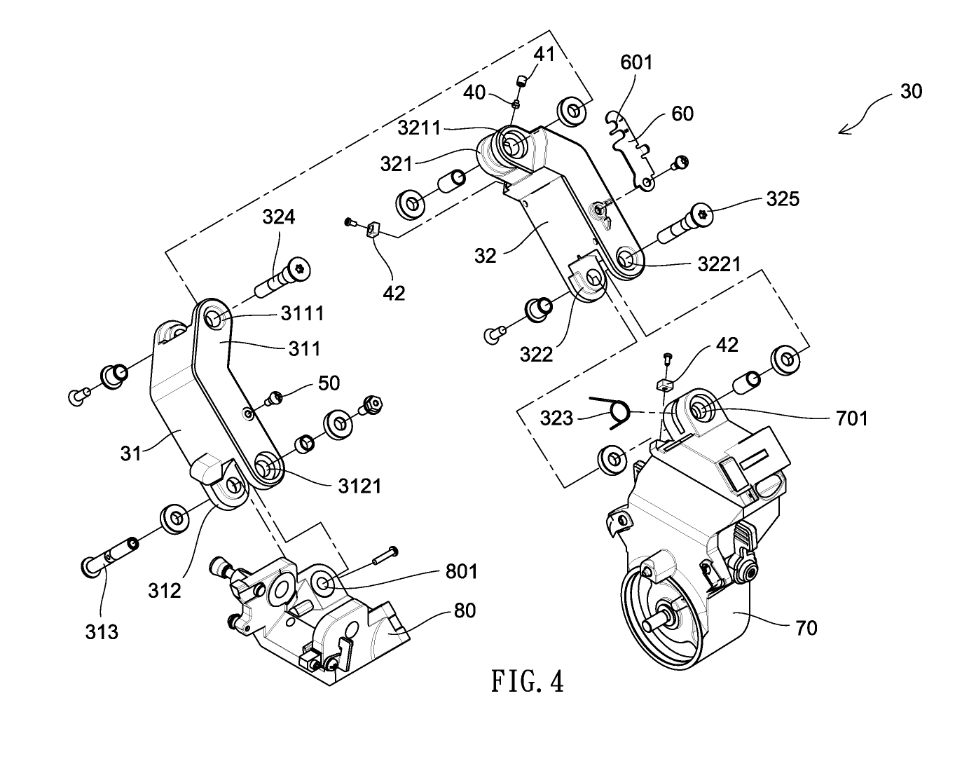

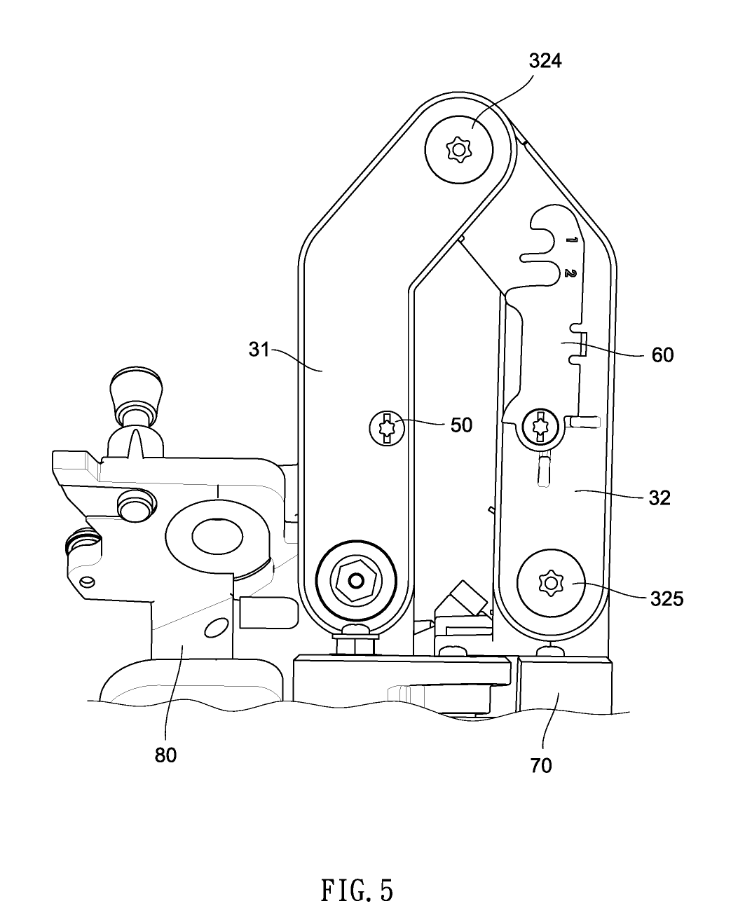

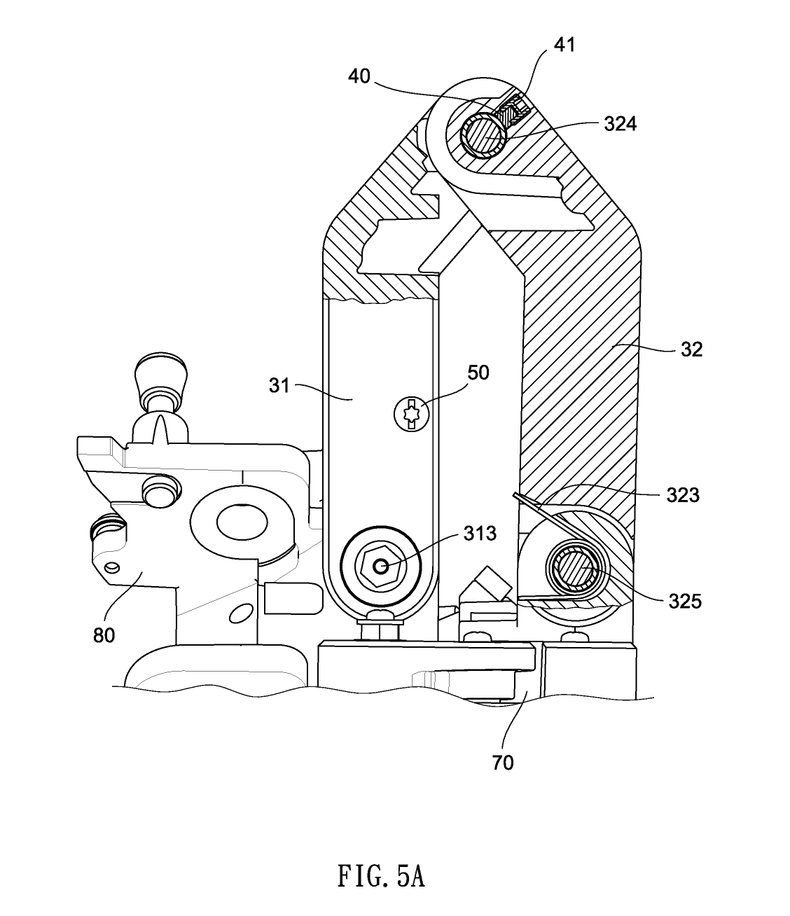

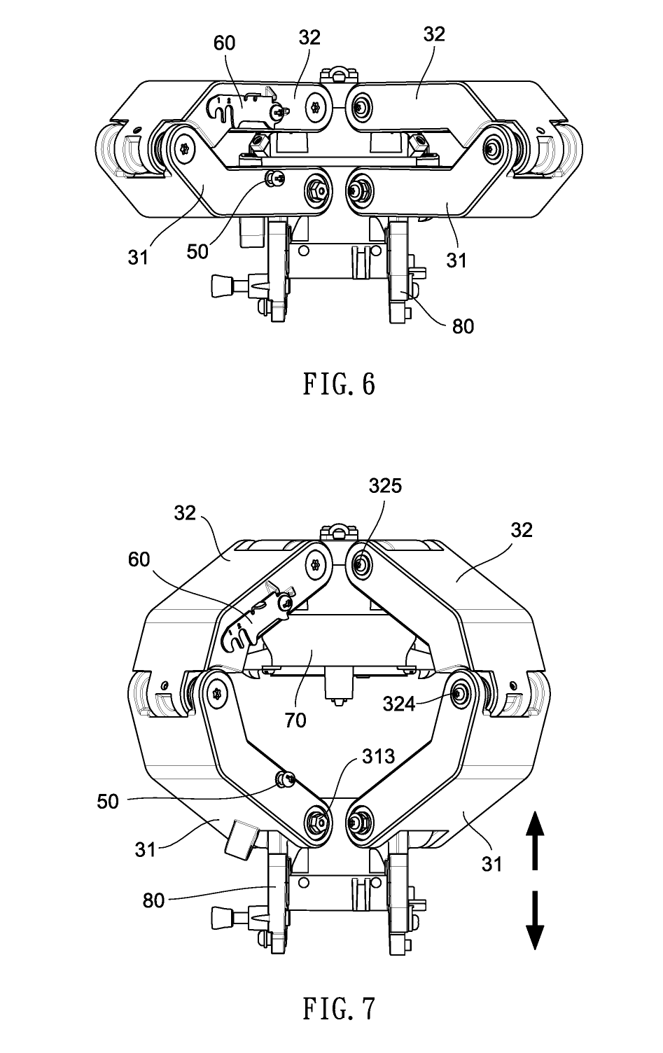

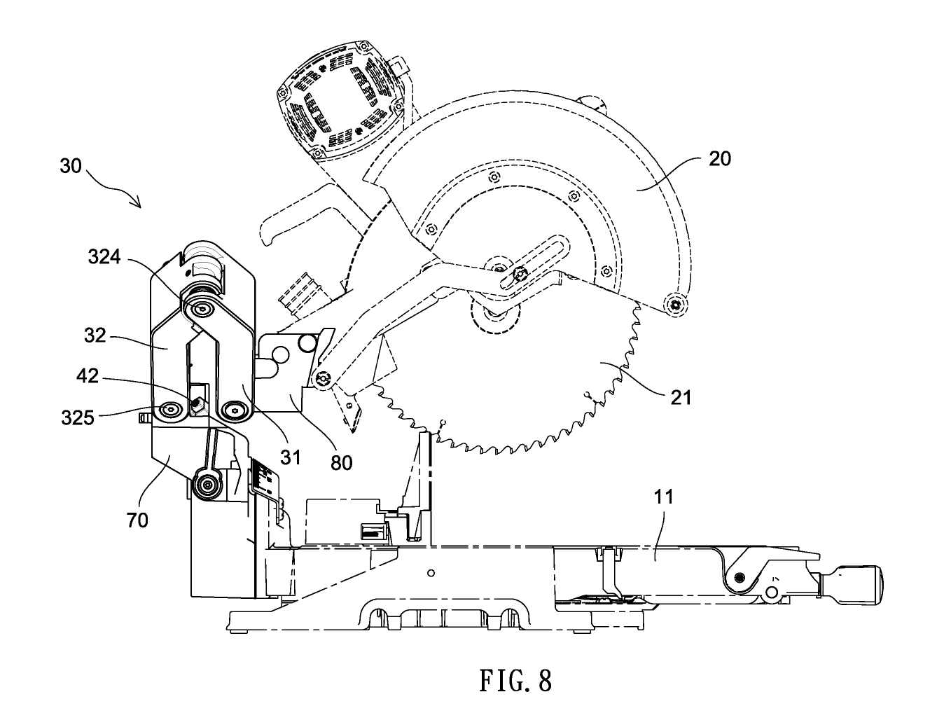

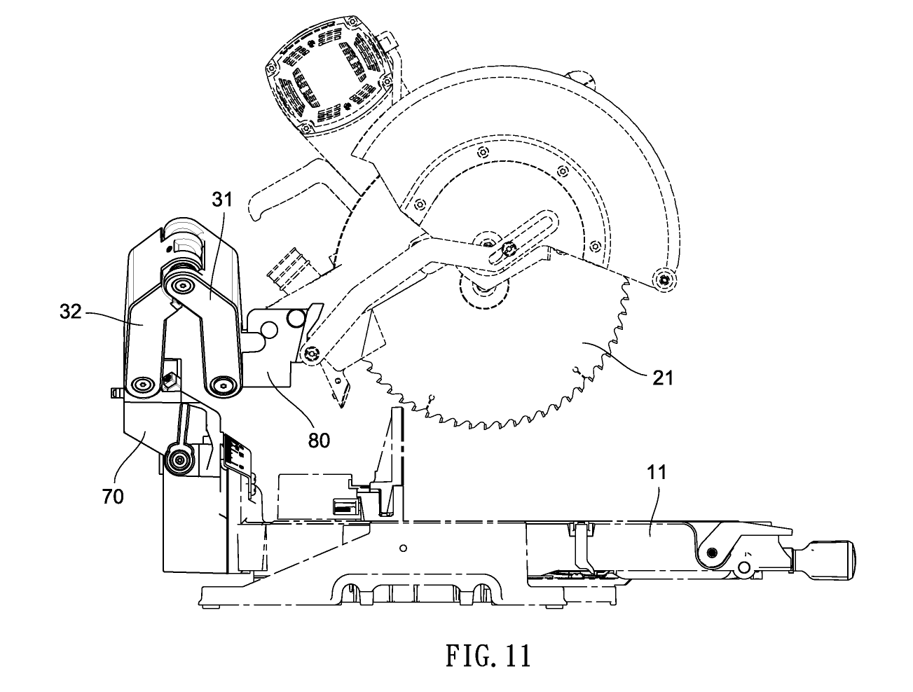

Referring to FIGS. 1 to 11, a power miter saw 1 in accordance with the invention comprises the following components as discussed in detail below.

A base 10 and a rotatable table 11 on the base 10 are provided. The table 11 is configured to receive a workpiece (not shown). A saw blade and motor mechanism 20 is configured to rotate a circular saw blade 21. Two linear guide mechanisms 30 as the subject of the invention are provided.

A lower positioning seat 70 interconnects the linear guide mechanisms 30 and a rear support seat 12 of the base 10. An upper connecting seat 80 interconnects the linear guide mechanisms 30 to the saw blade and motor mechanism 20. Thus, the saw blade and motor mechanism 20 is supported by the two symmetrically disposed linear guide mechanisms 30.

Each linear guide mechanism 30 comprises a first link 31 including a bifurcated first end 311 having two opposite first through holes 3111, and a bifurcated second end 312 having two opposite second through holes 3121; and a fastener 313 driven through the second through holes 3121 and two through holes 801 of the connecting seat 80 to fasten the first link 31 and the connecting seat 80 together.

The linear guide mechanism 30 further comprises a second link 32 including a bifurcated first end 321 having two opposite first through holes 3211, and a bifurcated second end 322 having two opposite second through holes 3221; a torsion spring 323 disposed in two through holes 701 of the positioning seat 70; a pivot 324 driven through the first through holes 3111 and the first through holes 3211 to pivotably secure the first and second links 31, 32 together; and a fastener 325 driven through the second through holes 3221, the torsion spring 323, and through holes 701 of the positioning seat 70 to fasten the second link 32 and the positioning seat 70 together. Thus, the second link 32 is configured as a spring-loaded member.

The linear guide mechanism 30 further comprises a friction member 40 in the first end 321 of the second link 32 contacting the pivot 324, an adjustment screw 41 disposed on the friction member 40 for adjusting friction between the pivot 324 and the friction member 40, and two catch blocks 42 secured to top of the positioning seat 70 and side of the second link 32 respectively, thereby limiting a pivotal angle of each of the first and second links 31, 32.

The linear guide mechanism 30 further comprises a projection 50 fastened on an outer surface of the first link 31, and a latch 60 pivotably secured to an outer surface of the second link 32 and including a first slot 601 at a first end, and a second slot 602 adjacent to the first slot 601.

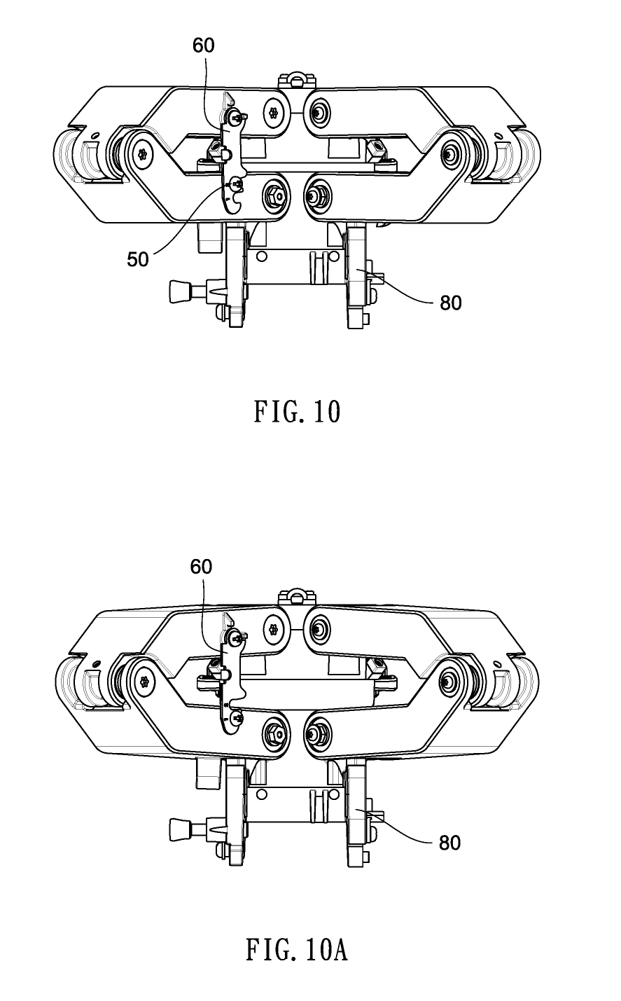

In a first locked position, the second slot 602 is placed on the projection 50 with a distance between the first link 31 and the second link 32 being minimum (see FIG. 10). In a second locked position, the first slot 601 is placed on the projection 50 with a distance between the first link 31 and the second link 32 being greater than the minimum distance so as to accommodate a workpiece to be cut (see FIG. 10A).

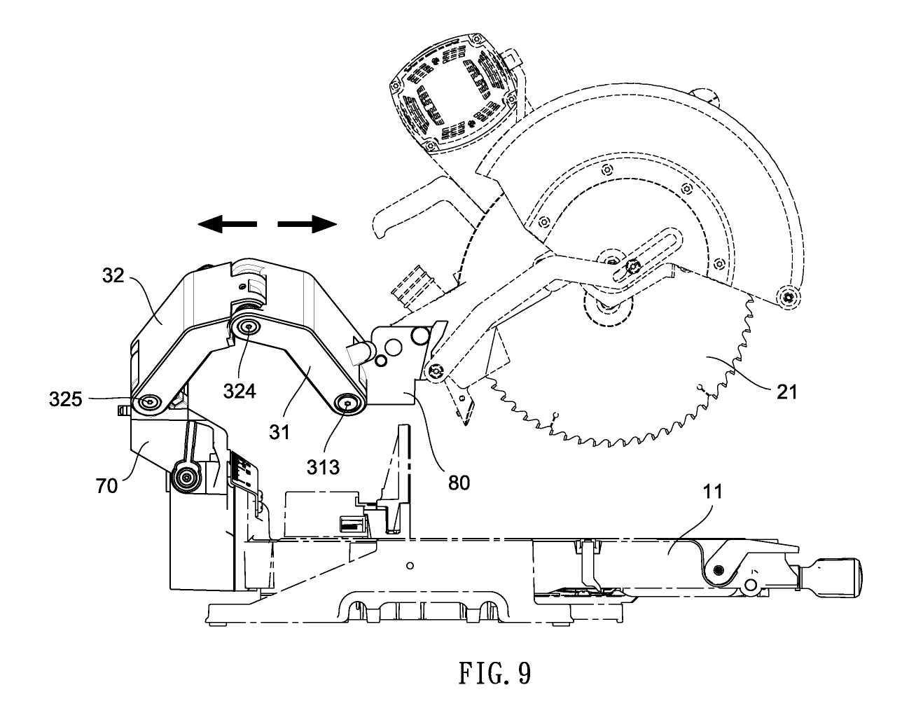

In an operating position (see FIG. 9), the first and second links 31, 32 are unlocked by the latch 60. Thus, each linear guide mechanism 30 may move along a predetermined linear path in either a forward or a rearward direction.

While the invention has been described in terms of preferred embodiments, those skilled in the art will recognize that the invention can be practiced with modifications within the spirit and scope of the appended claims.

What is claimed is:

1. A power miter saw comprising:
a base;
a table rotatably mounted on the base;
a saw blade and motor mechanism configured to rotate a circular saw blade thereof; and
two linear guide mechanisms each connected to a rear support seat of the base by means of a lower positioning seat, and connected to the saw blade and motor mechanism by means of an upper connecting seat, thereby supporting the saw blade and motor mechanism;
wherein the linear guide mechanism comprises:
a first link including a bifurcated first end having two opposite first through holes, and a bifurcated second end having two opposite second through holes; and a fastener driven through the second through holes and two through holes of the connecting seat to fasten the first link and the connecting seat together;
a second link including a bifurcated first end having two opposite first through hole, and a bifurcated second end having two opposite second through hole; a pivot driven through the first through holes and the first through hole to pivotably secure the first and second links together; and a fastener driven through the second through hole and two through holes of the positioning seat to fasten the second link and the positioning seat together;
a projection disposed on an outer surface of the first link; and
a latch pivotably secured to an outer surface of the second link and including a first slot at a first end, and a second slot adjacent to the first slot;
wherein in a first locked position, the second slot is placed on the projection;
wherein in a second locked position, the first slot is placed on the projection; and
wherein in an operating position, the first and second links are unlocked by the latch.

2. The power miter saw of claim 1, wherein the linear guide mechanism further comprises a friction member in the first end of the second link contacting the pivot, an adjustment screw disposed on the friction member for adjusting friction between the pivot and the friction member.

3. The power miter saw of claim 1, further comprising two catch blocks secured to top of the positioning seat and side of the second link respectively, thereby limiting a pivotal angle of each of the first and second links.

4. The power miter saw of claim 1, further comprising a biasing member disposed in the through holes of the positioning seat, and a fastener driven through the second through holes, the biasing member, and through holes of the positioning seat to fasten the second link and the positioning seat together, thereby configuring the second link as a spring-loaded member.

5. The power miter saw of claim 4, wherein the biasing member is a torsion spring.
